(19) United States
(12) Patent Application Publication
(10) Pub. No.: US 2014/0329148 A1
(43) Pub. Date: Nov. 6, 2014

(54) LEAD-ACID BATTERY

(71) Applicant: PANASONIC CORPORATION, Osaka (JP)

(72) Inventors: Kenji Izumi, Shizuoka (JP); Kazunari Ando, Aichi (JP); Yoshifumi Kuma, Shizuoka (JP)

(73) Assignee: PANASONIC CORPORATION, Osaka (JP)

(21) Appl. No.: 14/359,464

(22) PCT Filed: Jan. 23, 2013
(86) PCT No.: PCT/JP2013/000316

§ 371 Date: May 20, 2014

(30) Foreign Application Priority Data
Jan. 31, 2012 (JP) 2012-017686

(51) Int. Cl. H01M 4/36; H01M 4/583; H01M 4/56; H01M 4/14; H01M 10/12

(52) U.S. Cl. CPC H01M 4/364; H01M 4/14; H01M 10/12; H01M 4/56; H01M 4/583; H01M 2004/027
USPC 429/228

(57) ABSTRACT

The lead-acid battery of the present invention includes electrode plate units, each including a positive electrode plate, negative electrode plate, and a separator. The positive electrode plate is a positive electrode grid filled with paste of lead suboxide powder. The negative electrode plate is a negative electrode grid filled with paste of lead suboxide powder and carbon black. The positive electrode plate faces the negative electrode plate. The separator is provided between the positive electrode plate and the negative electrode plate. The amount of DBP oil absorption of the carbon black is more than or equal to 140 ml/100 g and less than or equal to 340 ml/100 g. The negative electrode plates are joined together by a strap of a lead alloy substantially without antimony.

### TECHNICAL FIELD

The present invention relates to lead-acid batteries, more particularly to a lead-acid battery for charge control vehicles and idle reduction vehicles.

### BACKGROUND ART

There is a constant demand for economical lead-acid batteries with high durability, which serve as starter batteries for automobiles. Such a lead-acid battery includes a battery box including a plurality of cell compartments. Each of the cell compartments includes an electrode plate unit including a positive electrode plate, a negative electrode plate, and a separator. The positive electrode plate is a positive electrode grid filled with paste of lead suboxide powder. The negative electrode plate is a negative electrode grid filled with paste of lead suboxide powder and carbon black. The separator is provided between the positive electrode plate and the negative electrode plate. The abutting electrode plate units are connected in series. The level of an electrolyte poured into the battery box is higher than the height of the electrode plate unit. A lid is closed to seal the battery box.

An overcharged lead-acid battery causes electrolysis of water in the electrolyte, thereby generating hydrogen gas and oxygen gas. Accordingly, the pressure in the cell increases, thereby discharging the gas to the outside of the battery and reducing the amount of the electrolyte. This causes many problems. The concentration of dilute sulfuric acid in the electrolyte increases, thereby corroding and degrading the positive electrode plate and reducing the capacity thereof. The level of the electrolyte is lowered, thereby causing the electrode plates to be exposed from the electrolyte and sharply decreasing the discharge capacity. A connection between the negative electrode plate and a strap is also corroded. To avoid such a reduction in the electrolyte of the lead-acid starter battery, storage batteries with a grid of a lead-calcium alloy are used practically. PATENT DOCUMENT 1 also discloses a lead-acid battery including negative electrode plates. At least these negative electrode plates are joined to each other by a strap of a lead alloy without antimony.

Recent lead-acid batteries mounted on charge control vehicles or idle reduction vehicles have been used under severe conditions such as a relatively large discharge amount or little charging opportunity. Accordingly, the improvement in the charge acceptance has been required to increase the SOC with little charging opportunity.

It is useful to add the carbon black (CB), as a conductive agent, having the improved conductivity to a negative electrode plate in order to improve the charge acceptance of a lead-acid battery. In addition to the additive, the conductivity of the CB depends on the surface area. The surface area of the CB is often measured with the amount of dibutyl phthalate (DBP) oil absorption.

PATENT DOCUMENTS 2-5 disclose that the CB having a large amount of DBP oil absorption (or a large specific surface) is added to a negative electrode plate to make a long-life lead-acid battery. In particular, PATENT DOCUMENTS 2 and 4 disclose in detail that the CB and a lignin compound are used together to improve the charge acceptance of the negative electrode plate. This CB has 100-300 ml/100 g or 450-550 ml/100 g of DBP oil absorption. The lignin compound is approximately 0.1-0.6 mass percent relative to a negative electrode active material.

### CITATION LIST

### Patent Document

PATENT DOCUMENT 1: Japanese Unexamined Patent Publication No. 2009-146872

PATENT DOCUMENT 2: Japanese Unexamined Patent Publication No. H05-174825

PATENT DOCUMENT 3: Japanese Unexamined Patent Publication No. 2002-063905

PATENT DOCUMENT 4: Japanese Unexamined Patent Publication No. 2006-196191

PATENT DOCUMENT 5: Japanese Unexamined Patent Publication No. 2007-273367

### SUMMARY OF THE INVENTION

### Technical Problem

Charge control vehicles and idle reduction vehicles have little charging opportunity. The lead-acid battery, with the technique of PATENT DOCUMENT 1, mounted on such vehicles has a significantly low charge acceptance because of the strap without antimony. This causes rapid battery depletion and a short battery life. The combination of the technique of PATENT DOCUMENT 1 and the techniques of PATENT DOCUMENTS 2-5 is useful for solving these problems. However, it has been found that a random combination of these techniques cause problems. Even a strap of a lead alloy without antimony decreases the level of the electrolyte. Accordingly, the electrode plate is exposed from the electrolyte and is likely to be corroded. In addition, the repeat of charge and discharge in a low SOC causes corrosion of a connection between the negative electrode plate and the strap, thereby causing a disconnection therebetween.

It is an object of the present invention to provide a lead-acid battery including a negative electrode and a strap wherein the lead-acid battery has a high charge acceptance suitable for, e.g., charge control vehicles and idle reduction vehicles having little charging opportunity, and the corrosion of a connection between the negative electrode and the strap is prevented.

### Solution to the Problem

To solve the above problem, a lead-acid battery of the present invention includes electrode plate units, each including a positive electrode plate, a negative electrode plate and a separator. The positive electrode plate is a positive electrode grid filled with paste of lead suboxide powder. The negative electrode plate is a negative electrode grid filled with paste of lead suboxide powder and carbon black. The positive electrode plate faces the negative electrode plate. The separator is provided between the positive electrode plate and the negative electrode plate. The amount of DBP oil absorption of the carbon black is more than or equal to 140 ml/100 g and less than or equal to 340 ml/100 g. The negative electrode plates are joined together by a strap of a lead alloy substantially without antimony. The lead suboxide powder is lead suboxide.

In a preferable embodiment, the amount of DBP oil absorption of the CB is 150-200 ml/100 g.

In a preferable embodiment, the CB is 0.05-0.7 mass percent relative to a negative electrode active material.

In a preferable embodiment, the CB is 0.1-0.5 mass percent relative to a negative electrode active material.

### Advantages of the Invention

The lead-acid battery of the present invention includes a negative electrode and a strap wherein the lead-acid battery has a high charge acceptance suitable for, e.g., charge control vehicles and idle reduction vehicles having little charging opportunity, and the corrosion of a connection between the negative electrode and the strap is prevented.

### BRIEF DESCRIPTION OF THE DRAWINGS

FIG. 1 is a cutaway view of a main portion of a lead-acid battery of the present invention.

### DESCRIPTION OF EMBODIMENTS

Charging a lead-acid battery causes electrolysis of water as a side reaction, in particular, at the end of the charge. The electrolysis of water is also accelerated by adding an element such as antimony having a lower hydrogen overvoltage than lead to a portion (e.g., a strap) that is in contact with the electrolyte. Thus, at least negative electrode plates of the present invention are joined together by a strap of a lead alloy without antimony to solve the problem that the level of an electrolyte is lowered, thereby causing the electrode plates to be exposed from the electrolyte and be corroded.

However, the lead-acid battery including the strap of a lead alloy without antimony has a low charge acceptance. Thus, the lead-acid battery mounted on a vehicle having little charging opportunity is likely to cause rapid battery depletion. For example, a typical vehicle receives current from only a lead-acid battery at the start of the engine of the vehicle. After that, this vehicle regularly receives current from an alternator, which also charges the lead-acid battery. However, a charge control vehicle or an idle reduction vehicle frequently stops charging the lead-acid battery after the start of the engine. Thus, this lead-acid battery is discharged while it stops being charged. Specifically, the vehicles detect that the alternator has charged the lead-acid battery for a fixed period of time, and then stop the charge (in order to reduce fuel consumption caused by the high speed rotation of the alternator). The lead-acid battery is also discharged when the vehicle is in an idle reduction state or is restarted. Such severe operating conditions are likely to cause the rapid battery depletion.

It is conceivable that the negative electrode plate including the CB having a large amount of DBP oil absorption (or a high conductivity) increases the charge acceptance, thereby solving the problems of both the corrosion and the rapid battery depletion. However, the inventors have found for the first time that the negative electrode plate including the CB having an excessively large amount of DBP oil absorption (or an excessively high conductivity) decreases the electrolyte, thereby causing the electrode plate to be exposed early from the electrolyte and corroded, even if the negative electrode plates are joined together by the strap of a lead alloy without antimony. The present invention is based on this new finding.

Specifically, the CB having more than 340 ml/100 g of DBP oil absorption causes electrolysis of water in the electrolyte on a surface of this excessive CB. This factor also causes a noticeable decrease in the electrolyte. Consequently, the electrode plate is exposed from the electrolyte and corroded, even if the negative electrode plates are joined together by the strap of a lead alloy without antimony. The CB having less than 140 ml/100 g of DBP oil absorption also significantly reduces the charge acceptance because of the strap of a lead alloy without antimony. Consequently, the adaptability to the vehicles having little charging opportunity is significantly reduced.

The CB of 0.05-0.7 mass percent, preferably 0.1-0.5 mass percent relative to a negative electrode active material further improves the advantage of the present invention. The amount of more than or equal to 0.05 mass percent makes the charge acceptance of the negative electrode plate high. The amount of less than or equal to 0.7 mass percent keeps the structure of the active material solid. Accordingly, the life characteristics are further improved.

### Embodiment

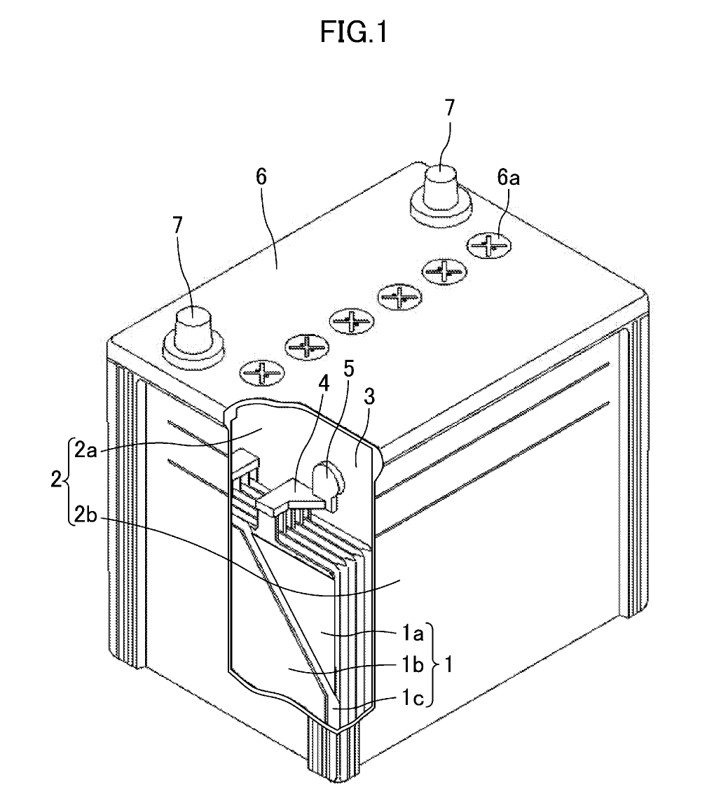

FIG. 1 is a cutaway view of a main portion (an electrode plate unit) of a lead-acid battery of this embodiment. An electrode plate unit 1 includes a positive electrode plate 1a, a negative electrode plate 1b, and a separator 1c. The positive electrode plate 1a is a positive electrode grid filled with paste of lead suboxide powder, purified water, and dilute sulfuric acid. The main component of this lead suboxide powder is lead oxide. The negative electrode plate 1b is a negative electrode grid filled with paste of lead suboxide powder, purified water, dilute sulfuric acid, CB, barium sulfate, and lignin. The main component of this lead suboxide powder is also lead oxide. The CB, the barium sulfate, and the lignin serve as additives. The separator 1c is provided between the positive electrode plate 1a and the negative electrode plate 1b. A battery box 2 includes a plurality of cell compartments 3 separated by partitions 2a. Each of the cell compartments 3 accommodates the electrode plate unit 1. The electrode plate unit 1 is connected with a strap 4 (that is connected with a connection member 5). This connection member 5 is connected through the partition 2a with a next connection member 5 having the opposite polarity. In this manner, the electrode plate units 1 are connected in series as many as the number of the cell compartments 3.

Each of the connection members 5 located on both ends of the series does not abut the connection member 5 having the opposite polarity. These connection members 5 on both ends are connected with binding posts (not shown). A lid 6 including a pair of bushings (not shown) is closed to seal the battery box 2. The bushings engage with the binding posts of the cell compartments 3 on both ends. The binding posts and the bushings are integrated by, e.g., welding to serve as a pair of terminals 7. A vent hole (not shown) is provided directly above each of the cell compartments 3. An electrolyte (not shown) is poured from this vent hole so that the level of the electrolyte is higher than the height of the electrode plate unit 1. Then, the vent holes are sealed with vent plugs 6a. Then, the lead-acid battery is charged under a predetermined condition.

This embodiment has two features. First, the at least negative electrode plates 1b are joined together by the strap 4 of a lead alloy substantially without antimony. Second, the amount of DBP oil absorption of the CB added to the negative electrode plates 1b is from 140-340 ml/100 g, preferably 150-200 ml/100 g.

The electrolysis of water is more accelerated by adding an element such as antimony having a lower hydrogen overvoltage than lead to the strap 4 that is in contact with the electrolyte than accelerated by adding only lead. Thus, the at least negative electrode plates 1b are joined together by the strap 4 of a lead alloy without antimony to solve the problem that the level of the electrolyte is lowered, thereby causing electrode plates (the positive electrode plates 1a and the negative electrode plates 1b) to be exposed from the electrolyte and be corroded. However, the lead-acid battery including the strap 4 of the lead alloy without antimony has a low charge acceptance. Thus, the lead-acid battery mounted on a vehicle having little charging opportunity is likely to cause rapid battery depletion.

It is conceivable that the negative electrode plate 1b appropriately including the CB having a large amount of DBP oil absorption (or a high conductivity) increases the charge acceptance, thereby solving the problems of both the corrosion and the rapid battery depletion. However, the negative electrode plate 1b including the CB having an excessively large amount of DBP oil absorption (or an excessively high conductivity) decreases the electrolyte, thereby causing the electrode plates to be exposed early from the electrolyte and corroded, even if the negative electrode plate 1b are joined together by the strap 4 of a lead alloy without antimony. Specifically, the CB having more than 340 ml/100 g of DBP oil absorption causes electrolysis of water in the electrolyte on a surface of the excessive CB. This factor also causes a noticeable decrease in the electrolyte. Consequently, the electrode plates are exposed from the electrolyte and corroded, even if the negative electrode plates 1b are joined together by the strap 4 of a lead alloy without antimony. This corrosion shortens the life of the lead-acid battery.

The CB having less than 140 ml/100 g of DBP oil absorption also significantly reduces the charge acceptance because of the strap 4 of a lead alloy without antimony. Consequently, the adaptability to vehicles having little charging opportunity is significantly reduced. That is, this lead-acid battery has too rapid battery depletion to be used for charge control vehicles or idle reduction vehicles. Thus, the amount of DBP oil absorption of the CB of this embodiment should be 140-340 ml/100 g.

The amount of DBP oil absorption of the CB is more preferably 150-200 ml/100 g. DBP oil absorption of more than or equal to 150 ml/100 g makes the charge acceptance of the negative electrode plate 1b high. DBP oil absorption of less than or equal to 200 ml/100 g keeps the structure of the active material solid. Accordingly, the charge acceptance is improved, and the life characteristics are further improved.

The numerical value of the amount of DBP oil absorption of the CB may be specified with only one material. For example, the value of 178 ml/100 g may be specified with only “VULCAN (a trademark) XC-72” (BK) of Cabot Corporation. The amount of DBP oil absorption of the BK is 178 ml/100 g. Alternatively, the numerical value may be varied with a plurality of materials. For example, the BK and “KETJENBLACK (a trademark) EC” (KB) of Lion Corporation may be appropriately mixed to specify any value between 178-350 ml/100 g. The amount of DBP oil absorption of the KB is 350 ml/100 g.

The CB of 0.05-0.7 mass percent, preferably 0.1-0.5 mass percent relative to the negative electrode active material further improves the advantage of the present invention. The amount of more than or equal to 0.05 mass percent makes the charge acceptance of the negative electrode plate 1b high. The amount of less than or equal to 0.7 mass percent keeps the structure of the active material solid. Accordingly, the life characteristics are further improved.

The “lead alloy substantially without antimony” in this embodiment implies that an extremely small amount of antimony might be mixed when recycled lead is used, or when the strap 4 is welded by burning to the connection member 5 of a lead alloy with antimony. In other words, the mixture of antimony of less than or equal to 0.03 mass percent has no trouble with the advantage of the present invention. The phrase “substantially without antimony” in the present invention implies including antimony mixed as an unavoidable impurity. This will be described in detail in the examples.

### EXAMPLES

### Example 1

A positive electrode plate 1a including an edge and an upper frame was produced as follows. An expanded sheet serving as a positive electrode grid 8 was produced by expanding a calendered sheet of a lead-calcium alloy by the reciprocating method. A paste was produced by mixing lead suboxide powder, sulfuric acid, and purified water. The main component of the lead suboxide powder was lead oxide. The positive electrode grid 8 was filled with this paste. Then, this positive electrode grid 8 was cut in a predetermined dimension and was dried.

A negative electrode plate 1b including an edge and an upper frame was produced as follows. An expanded sheet serving as a negative electrode grid was produced by expanding a calendered sheet of a lead-tin-calcium alloy by the reciprocating method. Lignin compound of 0.15 mass percent, barium sulfate of 1.0 mass percent, and CB of 0.3 weight percent relative to the lead suboxide powder were added to the negative electrode grid. The main component of the lead suboxide powder was lead oxide. The average value of the amount of DBP oil absorption of the CB was 140 ml/100 g by mixing BK and KB. The negative electrode grid was filled with a paste produced by mixing sulfuric acid with purified water. Then, this negative electrode grid was cut in a predetermined dimension and was dried.

An electrode plate unit 1 was produced by providing the positive electrode plate 1a and the negative electrode plate 1b face to face, and providing a microporous separator 1c between the positive electrode plate 1a and the negative electrode plate 1b. The microporous separator 1c was mainly made of a polyethylene resin. A battery box 2 of polypropylene (PP) included six cell compartments 3 separated by partitions 2a. Each of the six electrode plate units 1 was accommodated in each of the cell compartments 3. The edges of the positive electrode plate 1a and the negative electrode plate 1b were welded to a strap 4 of a lead alloy substantially without antimony (Pb—Sn). The electrode plate units 1 were connected in series together through connection members 5. Binding posts of the electrode plate units 1 on both ends were connected to one of polarities. The battery box 2 was sealed by a lid 6. This lid 6 was made of PP and included bushings. A pair of terminals 7 were produced by engaging, welding, and integrating the binding posts and the bushings. A predetermined dilute sulfuric acid (an electrolyte) was poured from a vent hole provided directly above each of the cell compartments 3 so that the level of the electrolyte was higher than the height of the electrode plate unit 1. The vent hole was sealed with an explosion-proof vent plug 6a including a porous filter. The value of the porous filter measured by a water manometer was within the range of 30-300 mm. Then, the battery was charged under a predetermined condition. In this manner, 80D26 defined by JIS D5103 (lead-acid starter battery) was produced.

### Examples 2-7 and Comparison Example 1

Lead-acid batteries were all produced in a similar manner of Example 1 except for an average value of the amount of DBP oil absorptions of CB. The average value of the amount of DBP oil absorption of “Denkablack (a trademark)” (DB) of DENKI KAGAKU KOGYO is 115 ml/100 g. The DB and BK were mixed together to set the average value of 150 ml/100 g (Example 2), 170 ml/100 g (Example 3), 185 ml/100 g (Example 4), 200 ml/100 g (Example 5), 270 ml/100 g (Example 6), 340 ml/100 g (Example 7), or 130 ml/100 g (Comparison Example 1).

### Comparison Example 2

A lead-acid battery was all produced in a similar manner of Example 1 except for the amount of DBP oil absorption of CB. The amount of DBP oil absorption was set to 350 ml/100 g by using only KB.

### Comparison Example 3

A lead-acid battery was all produced in a similar manner of Example 4 except for use of a lead alloy (Pb—Sb) with antimony of 3 mass percent for a strap 4 welded to an edge of a negative electrode plate 1b.

### Examples 8-13

Lead-acid batteries were all produced in a similar manner of Example 4 except for the amount of carbon black that was set to 0.03 mass percent (Example 8), 0.05 mass percent (Example 9), 0.1 mass percent (Example 10), 0.5 mass percent (Example 11), 0.7 mass percent (Example 12), or 0.8 mass percent (Example 13) relative to a lead oxide suboxide powder.

### Example 14

A lead-acid battery was all produced in a similar manner of Example 4 except for use of a lead alloy (Pb—Sn-Sb) with antimony of 0.03 mass percent as an unavoidable impurity for a strap 4 welded to an edge of a negative electrode plate 1b.

### Example 15

A lead-acid battery was all produced in a similar manner of Example 4 except for use of a lead alloy (Pb—Sb) with antimony of 3 mass percent for a strap 4 welded to an edge of a positive electrode plate 1a.

These lead-acid batteries were evaluated as follows. Table 1 shows the results.

(Charge Acceptance)

The “charge acceptance test 2” of JIS D5103 was conducted. Specifically, after discharged at a five-hour discharge current rate for 2.5 hours, the batteries were left until the temperature of the middle cells became zero degree. Then, the batteries were charged with a constant voltage of 14.4V. Then, 10 minutes later, the currents of the batteries were measured. From these currents, percentages of the charge acceptances were calculated with respect to the charge acceptance of Comparison Example 1, which was 100 percent. Table 1 shows these values. A larger percentage indicates a larger charge acceptance.

(Life Characteristics)

The test for reduction in the electrolyte was conducted. Under a temperature of 70 degrees, the batteries were charged for 100 hours with a constant voltage of 14.5V (maximum current of 25 A). During this charge, the batteries were vibrated vertically under an actual random vibrating condition. Then, the reduction in the mass of the lead-acid batteries (or the amounts of reduction in the electrolyte) were recorded. Then, these amounts of reduction in the electrolyte were divided by the total amount of the poured electrolyte to calculate the percentages of these values. Table 1 shows these results. A larger percentage indicates a larger reduction in the electrolyte. Moreover, under a temperature of 75 degrees, other samples were charged for 120 hours with a constant voltage of 14.0V (maximum current of 25 A). The samples were left for two days. Then, the samples were discharged for five seconds with 300 A. This cycle was repeated until the terminal voltage after the five second discharge became less than or equal to 3V. The terminal voltage of less than or equal to 3V indicates the end of life of the battery. Table 1 shows the number of cycles at the end of life. When the level of the electrolyte was below the lower level, the battery was refilled with the electrolyte to keep the electrolyte amount within an appropriate range. The samples at the end of life were disassembled, and the straps 4 of the negative electrode plates 1b were observed. Then, it was determined whether the cycle was ended by a disconnection caused by the corrosion. Table 1 shows these results.

TABLE 1

| | |
|---|---|
| Carbon Black (CB) | Life Characteristics |

| | | Antimony in Strap | | Amount of | | | Reduction | | |
|---|---|---|---|---|---|---|---|---|---|
| | | Positive | Negative | DBP | Adding | Charge | in | | |
| | | Electrode | Electrode | Absorption | Amount | Acceptance | Electrolyte | | Number |
| | | Plate Side | Plate Side | (ml/g) | (mass %) | (%) | (%) | Disconnection | of Cycle |
| Comparison | 1 | No | No | 130 | 0.3 | 100 | 7 | No | 8 |
| Example | | | | | | | | | |
| Example | 1 | No | No | 140 | 0.3 | 120 | 8 | No | 11 |
| Example | 2 | No | No | 150 | 0.3 | 125 | 9 | No | 15 |
| Example | 3 | No | No | 170 | 0.3 | 130 | 9 | No | 15 |
| Example | 4 | No | No | 185 | 0.3 | 140 | 10 | No | 15 |
| Example | 5 | No | No | 200 | 0.3 | 140 | 10 | No | 15 |
| Example | 6 | No | No | 270 | 0.3 | 140 | 11 | No | 13 |
| Example | 7 | No | No | 340 | 0.3 | 140 | 12 | Yes | 11 |
| Comparison | 2 | No | No | 350 | 0.3 | 140 | 20 | Yes | 6 |
| Example | | | | | | | | | |
| Comparison | 3 | No | 3 mass % | 185 | 0.3 | 145 | 20 | Yes | 11 |
| Example | | | | | | | | | |
| Example | 8 | No | No | 185 | 0.03 | 120 | 9 | No | 13 |
| Example | 9 | No | No | 185 | 0.05 | 125 | 10 | No | 14 |
| Example | 10 | No | No | 185 | 0.1 | 130 | 10 | No | 15 |
| Example | 11 | No | No | 185 | 0.5 | 140 | 11 | No | 15 |
| Example | 12 | No | No | 185 | 0.7 | 140 | 11 | No | 14 |
| Example | 13 | No | No | 185 | 0.8 | 140 | 13 | Yes | 13 |
| Example | 14 | No | 0.03 mass % | 185 | 0.3 | 140 | 10 | No | 15 |
| Example | 15 | 3 mass % | No | 185 | 0.3 | 140 | 10 | No | 15 |

The amount of DBP oil absorption of the CB of Comparison Example 1 was less than 140 ml/100 g. A lead alloy with antimony was used for the strap 4 of Comparison Example 1 welded to the edge of the negative electrode plate 1b, thereby reducing the charge acceptance. Accordingly, the life characteristics were also lowered. In addition, the amount of DBP oil absorption of the CB of Comparison Example 2 exceeded 340 ml/100 g. A lead alloy with antimony was used for the strap 4 of the negative electrode plate 1b of Comparison Example 3. Thus, the hydrogen overvoltages of Comparison Examples 2 and 3 were reduced, thereby improving the charge acceptances. However, this caused a large reduction in the electrolyte, thereby lowering the life characteristics.

In contrast to these comparison examples, a lead alloy substantially without antimony (mixed antimony is less than or equal to 0.03 mass percent) was used for the strap 4 of each of the examples welded to the edge of the negative electrode plate 1b. The amount of DBP oil absorption of the CB of these examples was 140-340 ml/100 g. Although a disconnection caused by corrosion was found in Examples 7 and 13, both the charge acceptances and the life characteristics of the examples were generally better than those of the comparison examples were. This advantage was found particularly when the amount of DBP oil absorption of the CB was 150-200 ml/100 g, or when the amount of the CB was 0.05-0.7 mass percent relative to the negative electrode active material. This advantage was found more particularly when the amount of the CB was 0.1-0.5 mass relative to the negative electrode active material. It is deduced that the effect of the amount of the CB to the charge acceptance and the amount of reduction in the electrolyte is based on the same mechanism as the effect of the amount of DBP oil absorption of the CB to the above characteristics.

The evaluations of Examples 4 and 15 indicate that the advantage of the present invention is not significantly affected by whether the strap 4 welded to the edge of the positive electrode plate 1a substantially includes antimony.

### INDUSTRIAL APPLICABILITY

The lead-acid battery of the present invention is industrially very useful because it is useful for starter batteries mounted on vehicles, particularly charge control vehicles and idle reduction vehicles having little charging opportunity.

### DESCRIPTION OF REFERENCE CHARACTERS

1 Electrode Plate Unit
1a Positive Electrode Plate
1b Negative Electrode Plate
1c Separator
2 Battery Box
2a Partition
2b Side Wall
3 Cell Compartment
4 Strap
5 Connection Member
6 Lid
6a Vent Plug
7 Terminal

1. A lead-acid battery, comprising:
electrode plate units, each including a positive electrode plate, a negative electrode plate and a separator, wherein
the positive electrode plate is a positive electrode grid filled with paste of lead suboxide powder,
the negative electrode plate is a negative electrode grid filled with paste of lead suboxide powder and carbon black,
the positive electrode plate faces the negative electrode plate,
the separator is provided between the positive electrode plate and the negative electrode plate,
an amount of DBP oil absorption of the carbon black is more than or equal to 140 ml/100 g and less than or equal to 340 ml/100 g, and
the negative electrode plates are joined together by a strap of a lead alloy substantially without antimony.

2. The lead-acid battery of claim 1, wherein
the amount of DBP oil absorption of the carbon black is more than or equal to 150 ml/100 g and less than or equal to 200 ml/100 g.

3. The lead-acid battery of claim 1, wherein
the carbon black is more than or equal to 0.05 mass percent and less than or equal to 0.7 mass percent relative to a negative electrode active material.

4. The lead-acid battery of claim 1, wherein
the carbon black is more than or equal to 0.1 mass percent and less than or equal to 0.5 mass percent relative to a negative electrode active material.
